(19) United States
(12) Patent Application Publication
(10) Pub. No.: US 2026/0120104 A1
(43) Pub. Date: Apr. 30, 2026

(54) DYNAMIC ANOMALY DETECTION IN CLOUD COMPUTING ENVIRONMENTS

(71) Applicant: Microsoft Technology Licensing, LLC, Redmond, WA (US)

(72) Inventor: Prabhakaran SETHURAMAN, Redmond, WA (US)

(21) Appl. No.: 18/931,265

(22) Filed: Oct. 30, 2024

(51) Int. Cl. G06Q 20/40

(52) U.S. Cl. CPC G06Q 20/4016

(57) ABSTRACT

A method for detecting an anomaly in resource utilization observed within a cloud computing platform includes observing an actual resource utilization for a customer of the cloud computing platform during an anomaly detection period; determining a historical utilization distribution for the customer that defines values of a resource utilization metric across repeated instances of a seasonal cycle; identifying a temporal location of an anomaly detection period within the seasonal cycle; filtering the historical utilization distribution to construct a distribution of seasonally-relevant values of the resource utilization metric, each value in the distribution of seasonally-relevant values corresponding to the temporal location within one of the repeated instances of the seasonal cycle; computing, based on the distribution of seasonally-relevant values, a resource utilization prediction for the customer; and automatically generating an anomaly alert in response to determining that the actual resource utilization of the customer satisfies a predefined relationship with the resource utilization prediction.

### BACKGROUND

For cloud customers who utilize cloud platforms to conduct business operations, unauthorized account access poses a significant financial and operational risk. If, for example, a fraudster gains unauthorized access to the account of a cloud customer and utilizes large quantities of data storage and/or processing resources that the customer subscribes to use, the cloud customer may be asked to front a large bill for the fraudster's resource utilization or/or be subject to operational disruptions such as delayed processing that results when the unauthorized party is consuming much of the customer's available resource quota.

To help protect cloud customers from instances of unauthorized access and also combat the larger issue of unnecessary resource consumption, cloud resource providers are beginning to adopt various automated tools that help detect and flag resource consumption “anomalies”—e.g., instances of resource consumption that appear atypical of the end user. When effective, these tools can automatically detect usage anomalies caused by instances of unauthorized account access as well as system malfunctions, such as processes that hang and unnecessarily tie up resources. Successful detection of these types of usage anomalies can lead to swift remedial actions, such as account lock-outs and investigations that resolve underlying causes of wasteful resource consumption.

Existing anomaly detection tools are not especially effective at predicting the unique patterns in resource usage that may be observed across diverse customer groups. Consequently, these presently existing anomaly detection tools tend to produce large numbers of false positives and/or false negatives.

### SUMMARY

According to one implementation, a method for detecting a resource utilization anomaly within a cloud computing platform includes: determining, for a customer of the cloud computing platform, a historical utilization distribution that defines values of a resource utilization metric for each of multiple fixed time increments across repeated instances of a seasonal cycle; identifying a temporal location of an anomaly detection period within the seasonal cycle; filtering the historical utilization distribution to construct a distribution of seasonally-relevant values of the resource utilization metric, each value in the distribution of seasonally-relevant values corresponding to the temporal location within one of the repeated instances of the seasonal cycle; computing, based on the distribution of seasonally-relevant values, a resource utilization prediction that quantifies a predicted resource utilization for the customer during the anomaly detection period; observing an actual resource utilization for the customer during the anomaly detection period; and automatically generating an anomaly alert in response to determining that the actual resource utilization of the customer satisfies a predefined relationship with the resource utilization prediction.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example cloud platform including an anomaly detector implementing the disclosed technology.

FIG. 2 illustrates aspects of an anomaly detection system implementing the herein-disclosed technology.

FIG. 3 illustrates an example system including a cloud computing platform that implements security provisions in response to anomaly alerts generated by an anomaly detector implementing the herein-disclosed technology.

FIG. 4 illustrates example operations for dynamically detecting resource usage anomalies in cloud computing environments.

FIG. 5 illustrates an example computing device for use in implementing the described technology.

### DETAILED DESCRIPTION

The herein-disclosed technology includes an adaptative anomaly detection tool that provides high detection accuracy for resource consumption anomalies while also reducing the number of false detections reported as compared to presently-existing anomaly detection tools employed for similar purposes.

As noted above, presently existing anomaly detection tools tend to be over-sensitive (generating false positives) or under-sensitive (failing to flag actual anomalies) when used to detect resource consumption anomalies. One reason for this is that these tools tend to employ traditional statistical approaches such as standard deviation, variance measures, and regression methods that fail to capture the nuances of customer-specific usage patterns, particularly trends that repeat “seasonally”—e.g., during a particular month each year, during a particular time frame each month, a particular day of each week, a particular hour of each day, or any combination thereof. Notably, different types of cloud platform customers may offer different types of web-based services that are characterized by different, industry-specific (or customer-specific) compute usage trends. For example, an online retailer may use cloud resources to process greater numbers of sales orders during the months of November and December due to holiday shopping, while an online payroll provider may use cloud resources to execute payroll-related processes on the same day of each month. Across longer periods of time, these types of seasonal resource usage patterns are also subject to change due to a plethora of factors that are difficult to predict. For example, compute resource utilization patterns related to online holiday shopping may be lower in years characterized by economic regression or depression than in other years. Likewise, different enterprises may increase or decrease their cloud resource utilization at dramatically different rates due to industry-specific trends in supply and demand, capital influx, and more.

Statistical approaches employed by currently-existing anomaly detection tools (e.g., fraud detection systems) tend to rely on thresholds that classify statistical outliers without any mechanism to adapt the detection thresholds to account for long-term seasonal, customer-specific usage trends that may be temporally relevant to timeframes being analyzed for anomalous activity. While some of these tools do rely on customer-specific data to set detection thresholds, the detection thresholds are typically calculated based on historical data and fixed thereafter (e.g., until the tool is reconfigured based on newer history data). Consequently, these existing tools are slow to adapt detection thresholds to account for short-term trends, leading to high numbers of false positives and negatives.

The herein-disclose anomaly detection system addresses the above-noted shortcomings, in part, by identifying seasonally-relevant data from a database for a detection period of interest and then using the seasonally-relevant data to set an anomaly detection threshold for the detection period of interest. As used herein, “seasonal data” refers to data quantifying resource usage in fixed-length time increments (e.g., a day or month) that repeat, at a regular frequency, within multiple instances of a longer fixed-length interval (referred to herein as a “seasonal cycle”) represented in a larger dataset. As used herein, the term “seasonally-relevant data” refers to seasonal data representing some portion of an available, larger dataset that has been identified as having temporal relevance to a detection period being analyzed for anomalous activity.

Using seasonally-relevant data to set anomaly detection thresholds leads to more accurate resource usage predictions than basing predictions on longer, more comprehensive datasets. This is due, in part, to the fact that the seasonally-relevant datasets are not clouded by irrelevant short-term trends (e.g., pertaining to other seasons). Since the identification and extraction of seasonally-relevant trend data is a key principle underlying the herein-disclosed technology, the following provides several examples of seasonal trends—e.g., trends that repeat cyclically in a dataset.

Assume, for example, that a large dataset includes values of a resource utilization metric quantifying the resource usage of a cloud customer each day over a time span of multiple years. From this large dataset, it is possible to identify different subsets of the data that are usable to identify seasonally-specific trends. For example, trends that repeat cyclically at a particular time of month may be best analyzed and understood by using a subset of the larger dataset that corresponds to a particular time of month. As a further example of this, a prediction for October 3^{rd} can be generated using data corresponding to January 3^{rd}, February 3^{rd}, March 3^{rd} . . . , etc. Alternatively, trends that repeat yearly, such as in the same month every year, may be best analyzed by using a subset of the larger dataset that corresponds to the particular month of year. For example, a prediction for the month of September might be generated using data corresponding to the month of September for the past ten previous years.

By identifying and utilizing seasonally-relevant data extracted from a larger dataset to make usage predictions, the disclosed anomaly detector is able to make more accurate predictions of customer-specific usage and, consequently, provide more accurate detection of usage anomalies.

In addition to determining and utilizing seasonally-relevant datasets to define detection thresholds, some implementations of the disclosed technology implement logic that provides for adaptively varying anomaly detection thresholds based on customer feedback pertaining to the accuracy of anomalies detected. If, for example, a customer provides feedback indicating that the anomaly detection tool is identifying large numbers of false positive detections, the anomaly detection logic within the tool automatically increases the value of a customer-specific parameter used to predict usage. This feedback-based dynamic variability in customer-specific anomaly detection thresholds allows the anomaly detector to accurately detect anomalies within complex usage patterns of individual users that evolve over time.

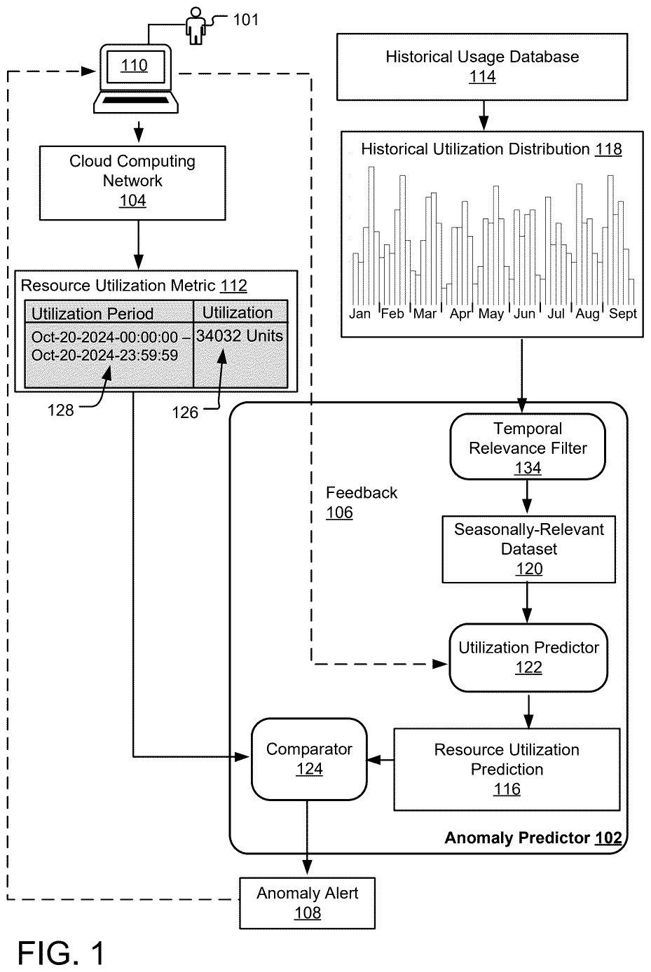

FIG. 1 illustrates an example cloud platform 100 including an anomaly detector 102 that predicts resource usage within a cloud computing network 104 that occurs on behalf of a cloud customer, such as single individual or entity, with access to an account of the cloud platform 100. The anomaly detector 102 uses historical usage data to predict usages of individual customers, monitors observed (actual) usages and generates anomaly alerts flagging instances of observed resource usage that appear anomalous in view of the predicted usages.

The cloud platform 100 is a web-based platform that makes hardware resources (e.g., servers, cloud storage, processing units) available to cloud customers, such as in the form of virtual networks configured on behalf of cloud customers, cloud-based data storage accounts, or processing units owned by the cloud provider and configured to execute web-based service(s) of the cloud provider on behalf of various different cloud customers (e.g., web-based pools of models in a model-as-a-service platform).

In one implementation, the cloud computing network 104 represents a single virtual network configured on behalf of a cloud customer to perform storage and processing operations of the cloud customer. In this case, the cloud-based computing network 104 includes one or more virtual machines (VMs) instantiated on physical servers that reside within data center(s) operated by the cloud platform 100. In another implementation, the cloud computing network 104 includes cloud-based servers configured to execute instances of a web-based service on behalf of cloud customers. For example, the cloud computing network 104 includes instances of one or more machine learning models instantiated on behalf of different customers within different model pools that are dynamically allocated processing resources (e.g., graphics processing units (GPUs)) from a shared resource pool.

Each cloud customer (e.g., a cloud customer 101) of the cloud platform 100 platform uses a customer machine 110 to interact with the cloud computing network 104, such as via a web-based control panel of the cloud platform 100. During ongoing nominal use operations, the cloud platform 100 tracks the quantity of computing resources used per unit time by the cloud customer 101. In one implementation, various processing devices (e.g., servers) within the cloud computing network 104 are configured to determine and periodically report values for a resource utilization metric 112 to a centralized entity of the cloud platform 100. The centralized entity, in turn, provides the reported usage values to the anomaly detector 102 and also stores the values in a historical usage database 114.

Each value of the resource utilization metric 112 describes a quantity of computing resources consumed by the cloud customer 101 during a corresponding utilization period 128. The phrase “consumed by the cloud customer” refers to any act or configuration performed by or on behalf of the cloud customer 101 that renders the corresponding resources unavailable for use by other cloud customers during the utilization period 128. For example, a quantity of memory is said to be consumed by the cloud customer 101 when the cloud customer 101 initiates a process that reserves the quantity of memory for a period of time, even if the process does not ultimately utilize that memory.

Units of resource utilization may vary from one implementation to another based, in part, on the nature of services provided by the cloud platform 100. Example units of the resource utilization metric 112 include memory utilization per unit time, storage utilization per unit time, token utilization per unit time (e.g., where “token” refers to the smallest processing unit of a language model), or any other resource unit type defined per unit time.

In FIG. 1, the historical usage database 114 can be understood as a database operated by a provider of the cloud platform 100. The historical usage database 114 stores values of the resource utilization metric 112 for various cloud customers across a long-term period of time, such as multiple years. The historical utilization distribution 118 defines values of the resource utilization metric 112 for each of multiple fixed time increments across repeated instances of a fixed-length interval. In the example of FIG. 1, the historical utilization distribution 118 defines a utilization value for the resource utilization metric 112 for each day across repeated instances of a month (e.g., all months within one or multiple years).

The anomaly detector 102 utilizes data stored in the historical usage database 114 to generate usage predictions (e.g., a resource utilization prediction 116) for individual cloud customers and particular time periods of interest, with each such period referred to herein as an “anomaly detection period.” Each resource utilization prediction 116 generated by the anomaly detector 102 estimates a value of the resource utilization metric 112 that is for a corresponding anomaly detection period and a particular cloud customer of the cloud platform 100.

The anomaly detector 102 compares the resource utilization prediction 116 for the cloud customer to a corresponding observed value 126 (e.g., an actual value) of the resource utilization metric 112 for the cloud customer 101 and, in response to determining that the observed value 126 of the resource utilization metric 112 satisfies a predefined relationship with the resource utilization prediction 116, generates an anomaly alert 108. For example, the anomaly alert 108 is generated and sent to the customer machine 110 when the actual observed value 126 exceeds the resource utilization prediction 116 for the anomaly prediction period.

As an initial step in generating the resource utilization prediction 116 for the cloud customer 101, the anomaly detector 102 accesses the historical usage database 114 to determine the historical utilization distribution 118 that is applicable to the cloud customer 101. In one implementation, the historical utilization distribution 118 for a cloud customer consists entirely or primarily of historical usage data that is specific to the cloud customer 101, such as historical values of the resource utilization metrics 112 reported by virtual machines configured on behalf of the cloud customer or platform agents that track resource usage specific to the cloud customer 101.

In scenarios where it is determined that the historical usage database 114 stores less than a predefined threshold quantity of the historical usage data for the cloud customer 101 (e.g., there is insufficient history data to make a prediction), the anomaly detector 102 may, in some implementations, determines the historical utilization distribution 118 for the cloud customer 101 by aggregating together historical usage data collected for a group of cloud customers identified as sharing one or more characteristics with the cloud customer 101. For example, the determined historical utilization distribution 118 is comprised of data collected for a group of cloud customers that all provide goods or services from the same or similar industry as the cloud customer that subscribe to the same subscription tier of service offered by the cloud platform 100, and/or that are associated with (e.g., conduct business operations within) a same geographical location as the cloud customer.

After determining the historical utilization distribution 118 applicable to the cloud customer, the anomaly detector 102 determines a “seasonal cycle” that is encompassed within the data of the historical utilization distribution 118, and that is temporally relevant to the anomaly detection period of interest. This seasonal cycle is used to construct a dataset used to make a usage prediction. This relevant “seasonal cycle” defines a fixed-length interval of time that is repeated multiple times within the historical utilization distribution 118. The length of the seasonal cycle may vary in different implementations; however, the seasonal cycle larger than the most granular time dimension available for the resource utilization metric (e.g., a usage quantity per day or per hour).

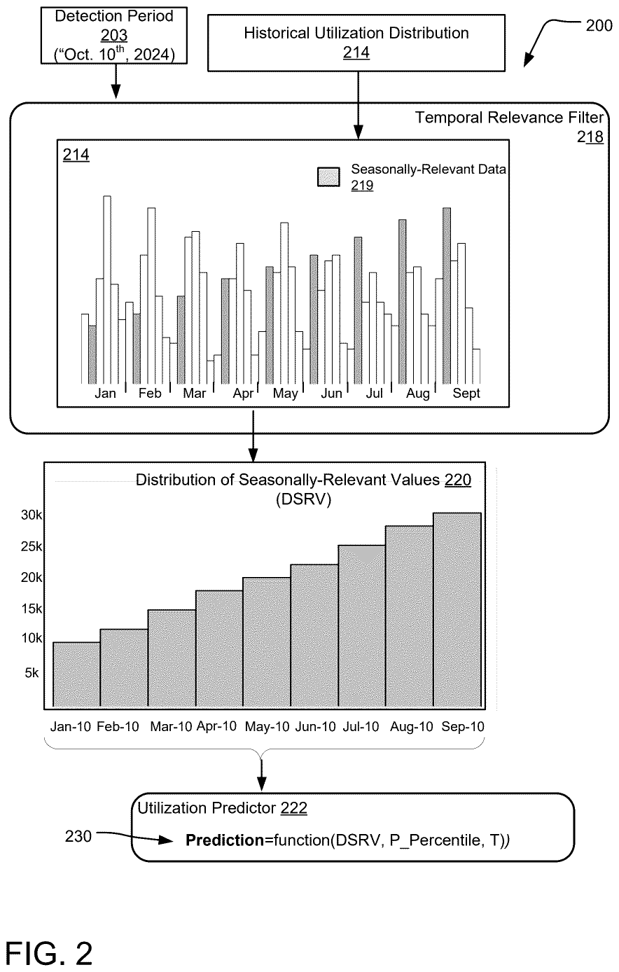

In some implementations, the anomaly detector 102 is configured to recognize and provide usage predictions based on a single (predefined and fixed) definition of the seasonal cycle. For example, the season cycle is a one-month cycle that repeats each new month of the year. As is further described in the example of FIG. 2, this definition of the seasonal cycle allows the resource utilization prediction 116 to be generated for a particular day of month based on trend data pertaining to the same day across many months represented in the historical utilization distribution 118. For example, the resource utilization prediction 116 is generated for the day of Oct. 20, 2024, based on a data subset (also referred to herein as a “seasonally-relevant dataset 120”) that includes actual resource utilization values for the 20^{th} of each month throughout the previous 1-year. This approach of defining the seasonal cycle as a monthly cycle is highly effective at yielding accurate usage predictions due, in part, to the fact that many cloud customers utilize cloud resources to execute business processes on a monthly cycle (e.g., payroll, revenue metrics, and more), thus leading to monthly trends in resource usage that can be predicted based on the day of month.

However, in other implementations, the anomaly detector 102 is configured to recognize and provide usage predictions based on a different definition for the seasonal cycle and/or configured to select between multiple selectable seasonal cycles, such as based on the identity of the cloud customer and/or the detection period of interest. Notably, some industries are characterized by unique trends that are not observed across all months of the year. For example, a cloud customer that provides online tax services is likely to experience cloud resource utilization increases during “tax season,” which typically refers to January 29^{th} through April 14^{th} of each year. For example, the anomaly detector 102 may be configured to utilize “tax season” as the applicable seasonal cycle when rendering usage predictions for this cloud customer and during an anomaly detection period that falls between January 29 and April 14^{th} (allowing the resource utilization prediction 116 to be based on trends specific to “tax season”). For example, to predict a usage on the second day of tax season, the anomaly detector 102 may analyze a dataset that consists of tax season usage data and, more specifically, usages recorded on the second day of tax season in previous years. In this same example, the anomaly detector 102 may be configured to define the seasonal cycle differently when generating usage predictions for days that do not fall within “tax season.” For example, an off-season cycle may be defined as one that encompasses all non-tax-season days (April 15-January 28). Here, usage predictions for June 1^{st} (a day that is not included in “tax season”) are generated based on trends observed across non-tax-season days.

By still further example, the “seasonal cycle” may alternatively be defined as a particular day of the year (e.g., the seasonal cycle is 24 hours and repeats only once each calendar year). For example, in the United States, internet-based sales tend to be very high on “Black Friday,” which refers to the day before the Thanksgiving holiday. Thus, if the historical usage database 114 includes usage history data for a sufficient number of years (e.g., ten or more), the anomaly detector 102 may be configured to define “Black Friday” as the applicable season when rendering usage predictions for a day of year that is also Black Friday. In this case, the seasonally-relevant dataset 120 is limited to historical data collected on Black Friday in previous years.

After determining the applicable seasonal cycle for the cloud customer (which is fixed and pre-defined in at least some implementations), the anomaly detector 102 next identifies the temporal location of an anomaly detection period of interest within the applicable seasonal cycle. This temporal location is used as a basis for generating the seasonally-relevant dataset 120. The seasonally-relevant dataset 120 can be understood as including a subset of the data represented within the historical utilization distribution 118 determined for the cloud customer. More specifically, the seasonally-relevant dataset 120 includes values for the resource utilization metric 112 corresponding to the same temporal location within the applicable seasonal cycle as the detection period (e.g., the period that the anomaly analysis/prediction is being performed for).

In FIG. 1, the seasonally-relevant dataset 120 is generated by a temporal relevance filter 134 that filters the historical utilization distribution 118 to redact all values except for a subset of the values that correspond to the same temporal location within the applicable seasonal cycle as the detection period. Assume, for example, that the seasonal cycle is “one-month” (meaning, the anomaly detector 102 is optimized to generate predictions based on usage trends that cycle monthly), and the anomaly detection period is Oct. 24, 2024. In this example, the temporal location of the detection period is the “20^{th}” of each month and the seasonally-relevant dataset 120 includes usage values from the historical utilization distribution 118 that correspond to the 20^{th} day of all months represented in the historical utilization distribution.

Alternatively, returning to the above example where the cloud customer is a tax service provider—if the recognized seasonal cycle is “tax season” (January 29^{th}-April 14^{th}), and the anomaly detection period of interest is Jan. 30, 2024, the temporal location of January 30^{th} within the applicable seasonal cycle (January 29^{th}-April 14^{th}) is the “second day of tax season.” In this case, the seasonally-relevant dataset 120 may consist of values from the historical utilization distribution 118 that all correspond to the second day of tax season in multiple previous years.

Notably, the herein-disclosed usage prediction methodology depends upon the recognized seasonal cycle being longer than the time period spanned by each anomaly detection period of interest (e.g. because the temporal location of the detection period of interest is determined relative to the larger seasonal cycle). Thus, in implementations where the seasonal cycle is defined to be a particular day that repeats once each year (e.g., Black Friday), the anomaly detector 102 makes predictions for periods of time that are shorter than 24 hours. For example, the anomaly detector 102 predicts resource usage for a time frame during the day of Black Friday (e.g., 9 am-noon or noon-3 pm) based on hourly data corresponding to the same time frame and on Black Friday of previous years.

The seasonally-relevant dataset 120 is input to a utilization predictor 122 that uses the seasonally-relevant dataset 120 as a basis for algorithmically generating the resource utilization prediction 116 for the detection period of interest. Example prediction methodologies are discussed in greater detail with respect to FIG. 2. In the example shown where the detection period of interest is October 20^{th}, the resource utilization prediction 116 predicts a resource consumption for Oct. 20, 2024.

A comparator 124 compares the resource utilization prediction 116 to the actual observed value 126 of the resource utilization metric 112 reported for the cloud customer by the cloud computing network 104 in association with the detection period of interest. In response to determining that the actual observed value 126 exceeds the resource utilization prediction 116 for the cloud customer, the anomaly detector 102 transmits an anomaly alert 108 to the cloud customer. For example, an alert system of the cloud platform 100 presents the alert to the cloud customer within a control screen that the user accesses via a web portal of the customer machine 110.

In some implementations, the cloud customer 101 provides feedback 106 in response to receiving each instance of the anomaly alert 108. For example, the anomaly alert 108 is presented as a user interface (UI) element that identifies the actual usage and the detection period of interest. The UI element is further configured to receive input from the customer indicating whether the anomaly alert 108 identified an event that the customer considers to be an actual anomaly (e.g., a higher-than-normal usage that the customer did not anticipate due to a system malfunction, unauthorized account usage, or other reason). In some implementations, the cloud platform 100 provides a user interface, e.g., via a web-based portal, that allows the cloud customer 101 to identify false negatives—e.g., actual anomalies in the customer's configuration that the customer observed by tracking published usage metrics but that did not trigger alerts of the anomaly detector 102.

In some implementations, the feedback 106 is used to refine detection thresholds specific to the cloud customer and also to the seasonally-relevant dataset 120. If, for example, the feedback 106 collected over a period indicates that the anomaly detector 102 is overly sensitive, the utilization predictor 122 may selectively increase a customer-specific parameter that is used in generating the resource utilization prediction 116, thereby decreasing the number of false positive alerts generated. In one implementation discussed in greater detail with respect to FIG. 2, the increase in this customer-specific parameter has the effect of raising future values of the resource utilization prediction 116 generated for the cloud customer in proportion to a rolling percentile smoothed value of a configurable percentile computed for the seasonally-relevant dataset 120 that is identified for anomaly detection period,

If, in contrast, the feedback 106 collected indicates that the anomaly detector 102 is under-sensitive and missing anomalies, the utilization predictor 122 may elect to decrease the value of the customer-specific parameter used in generating the resource utilization prediction. This decrease in the customer-specific parameter has the effect of lowering future values of the resource utilization prediction 116 generated for the cloud customer in proportion to the above-mentioned percentile threshold selected from the seasonally-relevant dataset 120, which, in turn, increases detector sensitivity.

The above-described dynamic feedback loop facilitates dynamic adaptation of prediction thresholds to match short-term customer trends, which improves accuracy of the anomaly alerts generated by the anomaly detector 102 as compared to alerts generated by existing anomaly detection tools that define thresholds based on long-term customer statistics.

FIG. 2 illustrates aspects of an example anomaly detection system 200 implementing the herein-disclosed technology. The anomaly detection system 200 includes a temporal relevance filter 218 that receives, as input, a detection period 203 (e.g., a period of interest for detecting usage anomalies) and a historical utilization distribution 214 that is used to generate a resource usage prediction for the detection period 203. In the implementation shown, the anomaly detection system 200 is assumed to be generating the resource usage prediction (e.g., prediction 130) on behalf of a cloud customer that leases compute resources from the cloud platform. The historical utilization distribution 214 represents a historical distribution of resource usage that has been identified as applicable to the cloud customer.

In one implementation, the historical utilization distribution 214 is selected based on an assessment of the quantity of historical resource utilization data stored for the cloud customer. For example, if there exists greater than a threshold quantity of resource utilization data for the cloud customer, the historical utilization distribution 214 consists of historical resource utilization data that has been collected from the cloud customer. However, in scenarios where the anomaly detection system 200 does not have access to at least the threshold quantity of historical usage data for the cloud customer, the historical utilization distribution 214 is generated by aggregating historical resource utilization data collected for other cloud customers identified as sharing one or more characteristics with the cloud customer. For example, customers to a cloud platform are grouped based on characteristic(s) such as industry type, size, subscription tier, and geographic locale.

When a new customer joins the platform, the new customer is assigned to a select one of the customer groups consisting of customers having one or more shared characteristics that are also shared by the new customer. The historical usage data for this assigned customer group is then used to define the historical utilization distribution 214 that is used to generate usage predictions for the new customer until the such time passes that the anomaly detection system 200 stores more than the threshold quantity of historical usage data for the new customer.

The temporal relevance filter 218 identifies seasonally-relevant data 219 based on a recognized seasonal cycle and the location of the detection period 203 within the defined seasonal cycle. In some implementations, the seasonal cycle is predefined and fixed with respect to all predictions generated by the anomaly detection system 200. For example, the seasonal cycle is one-month long and repeats each month. In other implementations, the temporal relevance filter 218 selects the seasonal cycle to use in generating each prediction, such as based on the identity of the cloud customer and/or the time period spanned by the detection period 203. For example, different seasonal cycles may be selected for different cloud customers based on the corresponding industry and time of year that the usage prediction is being generated for. For cloud customers operating in the online retail industry, a “holiday season” may be selected as a default seasonal cycle when the prediction period falls between Thanksgiving Day and Christmas Day. For cloud customers that provide online tax services, a “tax season” may be selected as a default seasonal cycle when the prediction period falls between January 29^{th} and April 4th. The use of these industry-specific seasonal cycles allows predictions to be based on relevant short-term trend data that is not clouded by short-term trend data specific to other “seasonal cycles” encompassed within the historical usage dataset, hereby improving quality of the resulting usage predictions.

In the example shown, the temporal relevance filter 218 is configured to recognize a seasonal cycle that is one-month in length, and the detection period 203 is a single day, “Oct. 10, 2024.” The temporal relevance filter 218 determines a temporal location of the detection period 203 relative to the corresponding (default or selected) seasonal cycle. In this case, the temporal location is the 10^{th} day of the month, and the temporal relevance filter 218 filters the historical utilization distribution 214 to redact all values that do not correspond to the 10^{th} day of a month. Data remaining after this filtering step is annotated in FIG. 2 as the “seasonally-relevant data 219.” The seasonally-relevant data 219 defines a distribution of seasonally-relevant values 220.

The distribution of seasonally-relevant values 220 is provided as input to a utilization predictor 222 that uses the distribution of seasonally-relevant values 220 to generate the prediction 230 of resource usage for the cloud customer and the detection period 203.

In FIG. 2, the prediction 230 is generated algorithmically and as a function of three input parameters—DSRV, P_Percentile, and T, where DSRV stands for “Distribution of Seasonally-relevant Values (e.g., distribution 220), P_percentile is a select (e.g., predefined) configurable percentile used to define a baseline prediction threshold, and T is a customer-specific parameter used to dynamically tune the baseline prediction threshold.

Equation 1, below, represents an example expression usable to generate the prediction 230. Within this equation, “UP” refers to “usage prediction,” which is a function of the above-described parameters DSRV, P_Percentile, and T.

$$U P = R PS ( DSRV , P\_Percentile ) + T * RPS ( DSRV , P\_Percentile ) \qquad ( 1 )$$

Within equation 1, the DSRV (the distribution of seasonally-relevant values 220) and P_Percentile (the predefined configurable percentile) are inputs to a rolling percentile smoothing (RPS) function. The RPS function smooths the DSRV (e.g., 220) within each of multiple fixed-length rolling windows (e.g., the last 30 days, last quarter, or last 12 months) and outputs a value that corresponds to the select configurable percentile (P_Percentile) term for the smoothed dataset. According to one implementation, this “smoothing” within each local window entails adjusting the values of the local window up or down to match a value of the configurable percentile term (a predefined selected value for P_Percentile) that is determined for that local window and based on the values of the DSRV that reside within the local window.

Assume, for example, that a rolling window of 90 days is used for the “smoothing” operations of the RPS function. Further assume that the distribution of seasonally-relevant values 220 spans the time-frame shown in FIG. 2 (January through September), and the predefined configurable percentile (P_Percentile) is “P_80.” In this case, the “RPS” operation within equation 1 above provides for smoothing the data values within each of multiple consecutive 90-day windows in the distribution and outputting a final value corresponding to the P_80 value for the smoothed distribution. Here, smoothing of values within the first 90-day window (spanning the months of January, February, March) entails determining a P_80 value for the mini distribution consisting of the values corresponding to the dates of January 10^{th}, February 10^{th}, and March 10^{th}. Assuming that the January 10^{th} value is 10,000, the February 10^{th} value is 12,000, and the March 10^{th} value is 15,000, the P_80 value for this local window is then 13,800. The RPS function then adjusts each of these three data points to equal to equal the P_80 value for this local window—13,8000. This is repeated for each 90-day window, such that the values of March 10^{th}, April 10^{th}, and June 10^{th} are locked at their corresponding P_80 value, and the values of July 10^{th}, August 10^{th}, and September 0^{th} are locked at their corresponding P_80 value. Then, the RPS function returns the P_80 value for the smoothed dataset as a whole. This smoothing ensures that the base threshold for usage prediction adapts to recent trends in resource utilization.

In various implementations, the predefined configurable percentile (P_Percentile) and local window size (used for smoothing) may be set differently, such as according to experimentally determined values that optimize prediction accuracy of the anomaly detection system 200 in view of the specific metrics represented within the dataset and/or characteristics of cloud customers that the predictions are being rendered for. Setting the configurable percentile term, P_Percentile, to a higher percentile such as to P95 or P100 causes the prediction 230 to be more conservative in the sense that actual usages are less likely to exceed the prediction 230 than in scenarios where the configurable percentile term is set to a comparatively low percentile, such as P75 or P80. It is suggested that the configurable percentile term be set to at least P95, as setting this value too low can result in larger numbers of false anomaly alerts being generated by the anomaly detection system 200.

In equation 1, above, the first term on the right-hand side of the equals sign, (RPS (DSRV, P_Percentile)), represents a baseline usage prediction whereas the second term on the right-hand-side of the equals sign, (T*RPS (DSRV, P_Percentile), represents a “buffer” that is being added to the baseline usage prediction to help refine sensitivity of the anomaly detection system 200 based on real-time user feedback received in response to anomaly alerts and/or anomalies reported by the customer that are not flagged by the anomaly detection system 200. This buffer term includes the customer-specific parameter T, which is set to a value between 0 and 1 that controls a weight applied as a multiplier to the output of above-described RPS function.

In one implementation, the initial value of T is determined by default or based on historical data analysis (e.g., experimentation and modelling to determine the best “T” for historical datasets with select characteristics). Over time and based on repeated instances of customer feedback (e.g., the feedback 106 shown and described in FIG. 1), the anomaly detection system 200 adjusts the customer-specific parameter, T, based on the accuracy of the anomaly alerts generated by the anomaly detection system 200 for the corresponding cloud customer, with “accuracy” being determined based on customer feedback, as generally described with respect to FIG. 1 and feedback 106. If the anomaly detection system 200 detects too many false positives, the customer-specific parameter, T, is adjusted upward to decrease detection sensitivity, which decreases the odds that an observed actual usage will exceed the corresponding predicted usage. If, in contrast, the anomaly detection system 200 fails to detect one or more usage anomalies for a cloud customer, the customer-specific parameter T is adjusted downward to increase detector sensitivity (e.g., by decreasing the size of the buffer term in Equation 1, which makes it more likely that actual usage will exceed the predicted usage and trigger an anomaly alert.

By example, consider a scenario where the distribution of seasonally-relevant values 220 includes the following usage data:
January-10: 10,000 resource units
February-10: 12,000 resource units
March-10: 15,000 resource units
April-10: 18,000 resource units
May-10: 20,000 resource units
June-10: 22,000 resource units
July-10: 25,000 resource units
August-10: 28,000 resource units

Assume that the prediction 230 is being generated for the month of March, with a rolling window (for smoothing) of 30 days, and that the configurable usage percentile (P_percentile) of equation 1 is set to P_75-meaning, the P_75 value of the distribution is determined and returned after smoothing. Since there is only one data point in this distribution corresponding to each local (30-day window), there is no smoothing (adjusting) of terms within each local window. The P_75 value for this distribution is 25,000 units. Therefore, the first term in equation 1 (e.g., RPS (DSRV, P_Percentile) is 25,000 and the second term is T*25,000. If “T” is set to 0.5, the buffer term, the usage prediction is 37,000 units.

This approach ensures that the rolling percentile is calculated dynamically and using the most relevant historical data available. Per this methodology, the usage prediction algorithm dynamically adapts to customer trends, including short-term usage fluctuations, which improves the overall accuracy of the usage predictions. In contrast, alternative modeling approaches to anomaly detection depend upon a one-time generated baseline. For example, a customer's historical resource utilization data is used to train a model to determine a threshold representative of the customer's nominal resource usage. This threshold is used as the basis for detecting anomalies for a prolonged period, such as several weeks or months. Occasionally, the model may be retrained with the latest customer data. However, this periodic retraining is subjective to operator choice, and nominal implementations of the model do not require or provide for automatic retraining or other dynamic updates to the detection threshold. Since these existing approaches lack a built-in mechanism for self-adapting to short-term fluctuations and trends, the resulting anomaly detection accuracy is far less accurate than that achieved via the above-described approach, which provides for smoothing data within fixed-length windows of a seasonally-relevant dataset and using a configurable percentile of the smoothed dataset to define an anomaly detection threshold.

According to one implementation, the usage prediction (e.g., prediction 230) serves as an anomaly detection threshold. The anomaly detection system 200 continuously monitors real-time usage data for a cloud customer within repeated “detection periods” (e.g., the detection period 203) and compares the observed real-time usage within each detection period to the prediction 230 for the same detection period (e.g., where the prediction 230 is generated by computing Equation, 1 as described above). When the observed usage for a detection period exceeds the prediction 230 for that detection period, an anomaly alert is transmitted to the corresponding cloud customer. The cloud customer provides the anomaly detection system 200 with feedback indicating whether the alert was accurate (as shown by feedback 106 in FIG. 1), and the customer-specific parameter (T in equation 1) is adjusted up or down to adjust the sensitivity of the detector based on the feedback.

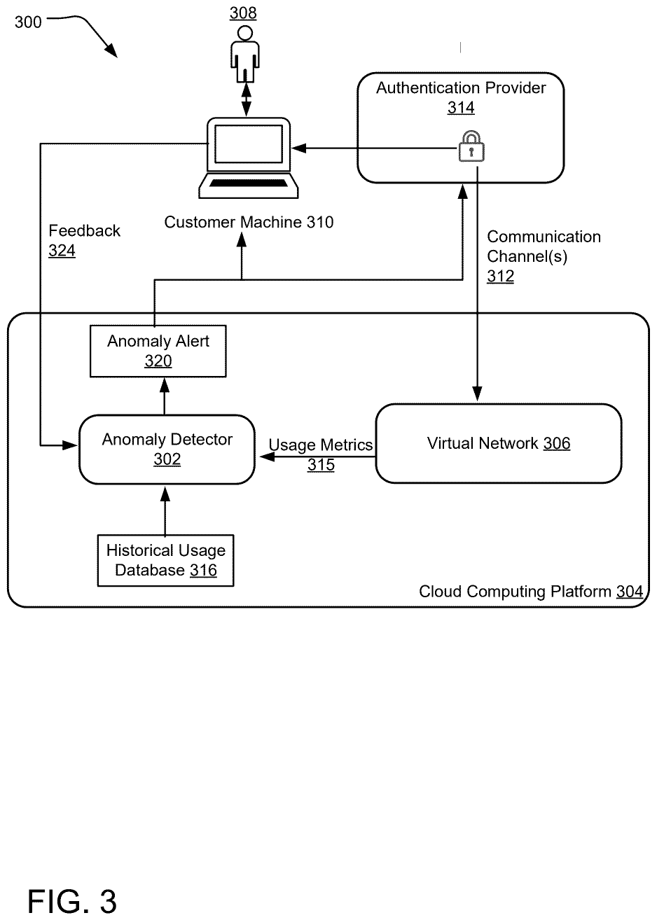

FIG. 3 illustrates an example system 300 including a cloud computing platform 304 that implements security provisions in response to anomaly alerts (e.g., an anomaly alert 320) generated by an anomaly detector 302 implementing the herein-disclosed technology. In one implementation, the cloud computing platform 304 provides hardware and software resources that allow remote users (cloud customers) to configure virtual networks (e.g., a virtual network 306) to execute workloads on behalf of the respective users. For example, the virtual network 306 is configured on behalf of an end user 308 and includes one or more virtual machines (VMs) that each execute on a data center server operated by a provider of the cloud computing platform 304. The end user 308 interacts with a customer machine 310 to communicate workloads and other information to the virtual network 306 across communication channel(s) 312.

The system 300 further includes an authentication provider 314 that provides authentication services for each different customer account on the cloud computing platform 204. When initializing a new session with the virtual network 306, the customer machine 310 presents security credentials to the authentication provider 314, and the authentication provider 314 conditions access to the virtual network 306 on the authentication of the credentials. In one implementation, the authentication provider 314 implements multi-factor authentication (MFA) that requires the end user 308 to provide two or more forms of access credential to gain access to the VMs within the virtual network 306. For example, the authentication provider 314 authenticates a first set of credentials (e.g., a username/password pair) that the end user 308 presents to the authentication provider 314 via a web-based portal. Subsequent to authenticating the first set of credentials, the authentication provider 314 requests, receives, and authenticates a secondary set of credentials. For example, the secondary set of credentials includes a biometric identifier (e.g., fingerprint, facial or retinal image), or a code that the authentication provider 314 transmits to the end user 308 via email or text message.

Within the virtual network 306, certain types of events trigger an MFA request-meaning, the end user's access to the communication channel(s) 312 is temporarily interrupted by the authentication provider 314 and renewed access to the virtual network 306 is conditioned upon receipt and authentication of one or more of the MFA security credentials from the end user 308. Within the system 300, each anomaly alert generated by the anomaly detector 302 triggers this type of MFA request.

The virtual network 306 is coupled to a control panel (not shown) of the cloud computing platform 304 that collects usage metrics 315 from the virtual network 306. For example, the usage metric quantifies CPU and GPU utilization of the end user 308 in time-based units. Actual observed usages are provided as inputs to the anomaly detector 302 and also stored in a historical usage database 316.

The anomaly detector 302 uses data in the historical usage database 316 to generate predictions of resource usage by the virtual network 306 for rolling time increments, such as each hour of the day or once each day (the “detection period”). Predictions are generated per a methodology consistent with that disclosed with respect to either FIG. 1 or FIG. 2—that is, the anomaly detector 302 identifies a dataset that is seasonally-relevant to the detection period and algorithmically predicts usage for the prediction period, such as by using equation 1, above. The anomaly detector 302 compares the usage prediction for each detection period to a corresponding actual usage observed within the virtual network 306 (e.g., as indicated by the usage metrics 315).

When the actual usage for a prediction period exceeds the predicted usage, the anomaly detector 302 generates an anomaly alert 320, which triggers an MFA request by the authentication provider 314. In this case, traffic from the customer machine 310 is temporarily prohibited from reaching corresponding destinations within the virtual network 306. The authentication provider 314 prompts the end user 308 to re-provide one or more of the MFA credentials and restores the flow of communications between the end user 308 and the virtual network 306 in response to successful authentication of the received MFA credential(s).

If an incorrect MFA credential is supplied in response to the MFA request, the account of the end user 308 may be temporarily locked and/or flagged for further investigation. This ensures abrupt termination of resource utilization in account takeover situations that otherwise result in ongoing, wasteful resource consumption.

In addition to triggering the MFA request of the authentication provider 314, the anomaly alert 320 is conveyed to the customer machine 310. For example, the anomaly alert 320 is presented within a control panel accessible through a web-based portal that the end user 308 accesses, using account credentials, to view information pertaining to the customer's account on the cloud computing platform 304. In one implementation, the anomaly alert 320 identifies the anomaly detection period as well as the predicted and observed resource utilization of the customer during the detection period. The control panel includes interactive UI elements that allow the end user 308 to provide feedback 324 that indicates whether or not the end user 308 believes that the recorded usage was due to unauthorized account access or other suspicious cause that merits further investigation.

If the feedback 324 indicates that the anomaly alert 320 did not correspond to an actual anomaly (e.g., the customer indicates that the alert was a false positive), the anomaly detector 302 dynamically increases the value of customer-specific parameter (e.g., T in equation 1) to reduce the likelihood of additional false positive detections in the future. The control panel may also routinely present actual utilizations metrics to the end user 308 and UI element(s) that allow the user to submit information pertaining to suspected usage anomalies not flagged by the anomaly detector 302. For example, the user can manually notify the cloud provider in the event of a suspected account takeover issue or possible configuration malfunction resulting in a. reported resource utilization that exceeds what the customer expected. Thus, if the feedback 324 indicates that the anomaly detector 302 failed to detect an actual anomaly, the anomaly detector dynamically decreases the value of the customer-specific parameter to increase the likelihood of automatically detecting future usage anomalies.

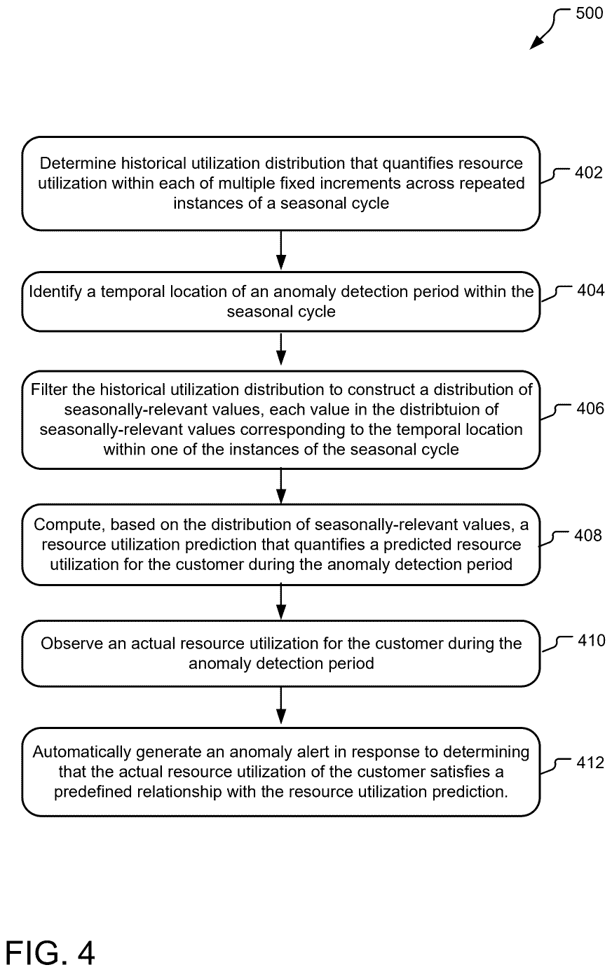

FIG. 4 illustrates example operations 400 for dynamically detecting resource usage anomalies in cloud computing environments. A dataset construction operation 402 determines, for a cloud customer, a historical utilization distribution that includes values that quantify resource utilization within each of multiple fixed increments across repeated instances of a seasonal cycle.

An identifying operation 404 identifies a temporal location of an anomaly detection period within the seasonal cycle. If, for example, the seasonal cycle is defined as a one-month cycle that repeats each month, the identifying operation 404 entails identifying a time of month (e.g., day of month) corresponding to the detection period.

A filtering operation 406 filters the historical utilization distribution to construct a distribution of seasonally-relevant values (e.g., a subset of the values within the historical utilization distribution). Each value in the distribution of seasonally-relevant values corresponds to the temporal location within one of the instances of the seasonal cycle. Thus, filtering entails identifying a subset of the fixed time increments within the historical utilization distribution that correspond to the temporal location and preserving the corresponding values while filtering all other values from the historical utilization distribution.

A computation operation 408 uses the distribution of seasonally-relevant values to generate (compute) a resource utilization prediction that quantifies a predicted resource utilization for the customer during the anomaly detection period. In one implementation, the resource utilization prediction is determined based, at least in part, on configurable percentile of the distribution of seasonally-relevant values. For example, the resource utilization is computed using equation 1, as defined herein.

An observation operation 410 observes an actual resource utilization for the customer during the anomaly detection period, and an anomaly generation operation 412 automatically generates an anomaly alert in response to determining that the actual resource utilization of the customer satisfies a predefined relationship with the resource utilization prediction for the customer (e.g., if the resource utilization prediction exceeds the actual usage or exceeds the actual usage by at least a predefined margin). In some implementations, the anomaly alert triggers security provisions, such as an MFA credentials request and/or account locking, as is described with respect to FIG. 3.

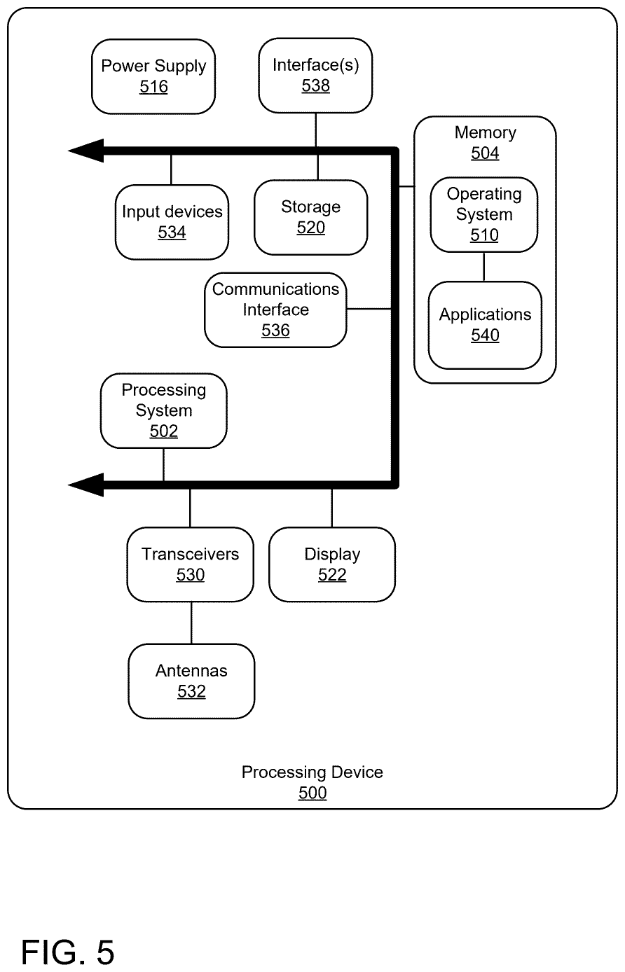

FIG. 5 illustrates an example computing device 500 for use in implementing the described technology. The computing device 500 may be a client computing device (such as a laptop computer, a desktop computer, or a tablet computer), a server/cloud computing device, an Internet-of-Things (IoT), any other type of computing device, or a combination of these options. The computing device 500 includes one or more hardware processor(s) 502 and a memory 504. The memory 504 generally includes both volatile memory (e.g., RAM) and nonvolatile memory (e.g., flash memory), although one or the other type of memory may be omitted. An operating system 510 resides in the memory 504 and is executed by the processor(s) 502. In some implementations, the computing device 500 includes and/or is communicatively coupled to storage 520.

In the example computing device 500, as shown in FIG. 5, one or more software modules, segments, and/or processors, such as applications 550 (e.g., the anomaly detector 302) are loaded into the operating system 510 on the memory 504 and/or the storage 520 and executed by the processor(s) 502. The storage 520 may store historical resource utilization data for a customers of a cloud platform as well as customer-specific detection parameters used to predict customer usage and set detection thresholds.

The computing device 500 may include one or more communication transceivers 530, which may be connected to one or more antenna(s) 532 to provide network connectivity (e.g., mobile phone network, Wi-Fi®, Bluetooth®) to one or more other servers, client devices, IoT devices, and other computing and communications devices. The computing device 500 may further include a communications interface 536 (such as a network adapter or an I/O port, which are types of communication devices) that is used to establish connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 634 such that a user may enter commands and information (e.g., a keyboard, trackpad, or mouse). These and other input devices may be coupled to the server by one or more interfaces 538, such as a serial port interface, parallel port, or universal serial bus (USB). The computing device 500 may further include a display 522, such as a touchscreen display.

The computing device 500 may include a variety of tangible processor-readable storage media and intangible processor-readable communication signals. Tangible processor-readable storage can be embodied by any available media that can be accessed by the computing device 500 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In some aspects, the techniques described herein relate to a method for detecting a resource utilization anomaly within a cloud computing platform, the method including: determining, for a customer of the cloud computing platform, a historical utilization distribution that defines values of a resource utilization metric for each of multiple fixed time increments across repeated instances of a seasonal cycle; identifying a temporal location of an anomaly detection period within the seasonal cycle; filtering the historical utilization distribution to construct a distribution of seasonally-relevant values of the resource utilization metric, each value in the distribution of seasonally-relevant values corresponding to the temporal location within one of the repeated instances of the seasonal cycle; computing, based on the distribution of seasonally-relevant values, a resource utilization prediction that quantifies a predicted resource utilization for the customer during the anomaly detection period; observing an actual resource utilization for the customer during the anomaly detection period; and automatically generating an anomaly alert in response to determining that the actual resource utilization of the customer satisfies a predefined relationship with the resource utilization prediction.

In some aspects, the techniques described herein relate to a method, wherein the historical utilization distribution is specific to the customer and the distribution of seasonally-relevant values consists of customer-specific historical values for the resource utilization metric.

In some aspects, the techniques described herein relate to a method, wherein the historical utilization distribution includes historical resource usage data collected for a group of customers identified as sharing a characteristic with the customer, the characteristic being selected from a group including: an industry of goods or services offered by the customer; a subscription tier of the customer; a geographical location associated with the customer;

In some aspects, the techniques described herein relate to a method, wherein computing the resource utilization prediction further includes: determining a value corresponding to a configurable percentile for the distribution of seasonally-relevant values; and computing the resource utilization prediction based on the value.

In some aspects, the techniques described herein relate to a method, wherein computing the resource utilization prediction further includes: defining a smoothed dataset by applying a smoothing function to smooth each of multiple fixed-length windows within the distribution of seasonally-relevant values; and defining an anomaly detection threshold based on a configurable percentile of the smoothed dataset.

In some aspects, the techniques described herein relate to a method, wherein computing the resource utilization prediction further includes: determining a buffer term by multiplying a customer-specific parameter by the value, the customer-specific parameter having a value that is set, at least in part, based on feedback from the customer in response to a previously-generated anomaly alert, wherein the resource utilization metric is based on a sum of the value and the buffer term.

In some aspects, the techniques described herein relate to a method, further including: receiving feedback from the customer indicating that the anomaly alert did not correspond to an actual anomaly; in response to the feedback, generating an updated value for the customer-specific parameter by increasing a previous value of the customer-specific parameter; re-generating the resource utilization prediction for a different detection period based on the updated value.

In some aspects, the techniques described herein relate to a method, wherein the cloud computing platform includes a virtual network configured for the customer and automatically generating the anomaly alert further includes: temporarily blocking a flow of communications between the customer and the virtual network; prompting the customer to provide a credential to a security provider and restoring the flow of communications in response to successful authentication of the credential.

In some aspects, the techniques described herein relate to a system including: a cloud computing platform that provides processing resources to a cloud customer; and an anomaly detector stored in memory and deployed within the cloud computing platform to: observe an actual resource utilization of a cloud customer during an anomaly detection period; determine a historical utilization distribution for the cloud customer that defines values of a resource utilization metric for each of multiple fixed time increments across repeated instances of a seasonal cycle; identify a temporal location of the anomaly detection period within the seasonal cycle; construct a distribution of seasonally-relevant values of the resource utilization metric based on the historical utilization distribution, the distribution of seasonally-relevant values including values within the historical utilization distribution that correspond to the temporal location within the repeated instances of the seasonal cycle; compute, based on the distribution of seasonally-relevant values, a resource utilization prediction that quantifies a predicted resource utilization for the cloud customer during the anomaly detection period; and automatically generate an anomaly alert in response to determining that the actual resource utilization of the cloud customer exceeds the resource utilization prediction computed for the cloud customer.

In some aspects, the techniques described herein relate to a system, wherein the historical utilization distribution is specific to the cloud customer and the distribution of seasonally-relevant values consists of customer-specific historical values for the resource utilization metric that correspond to the temporal location within the repeated instances of the seasonal cycle.

In some aspects, the techniques described herein relate to a system, wherein the historical utilization distribution includes historical utilization data collected for a group of customers identified as sharing a characteristic with the cloud customer, the characteristic being selected from a group including: an industry of goods or services offered by the cloud customer; a subscription tier of the cloud customer; and a geographical location associated with the cloud customer;

In some aspects, the techniques described herein relate to a system, wherein the anomaly detector is configured to compute the resource utilization prediction by performing operations that include: determining a value corresponding to a configurable percentile for the distribution of seasonally-relevant values; and computing the resource utilization prediction based on the value.

In some aspects, the techniques described herein relate to a system, wherein the anomaly detector determines is configured to compute the resource utilization prediction by performing operations that include: defining a smoothed dataset by applying a smoothing function to smooth each of multiple fixed-length windows within the distribution of seasonally-relevant values; and defining an anomaly detection threshold based on a configurable percentile of the smoothed dataset.

In some aspects, the techniques described herein relate to a system, wherein computing the resource utilization prediction further includes: determining a buffer term by multiplying a customer-specific parameter by the value, the customer-specific parameter having a value that is set, at least in part, based on feedback provided by customer in response to a previously-generated anomaly alert; and adding the value to the buffer term, wherein the resource utilization prediction is based on a sum of the value and the buffer term.

In some aspects, the techniques described herein relate to a system, wherein the anomaly detector is further configured to: receive feedback from the cloud customer indicating that the anomaly alert did not correspond to an actual anomaly; and in response to the feedback, generating an updated value for the customer-specific parameter by increasing a previous value of the customer-specific parameter; re-generating the resource utilization prediction for a different detection period based on the updated value of the customer-specific parameter.

In some aspects, the techniques described herein relate to a system, wherein the cloud computing platform includes a virtual network configured for the cloud customer and automatically generating the anomaly alert further includes: temporarily blocking a flow of communications between the cloud customer and the virtual network; prompting the cloud customer to provide a credential; and restoring the flow of communications between the cloud customer and the virtual network in response to successful authentication of the credential.

In some aspects, the techniques described herein relate to one or more tangible processor-readable storage media encoding instructions for executing a process including: accessing a database to retrieve historical usage data for a customer of a cloud computing platform, the historical usage data including values of a resource utilization metric quantifying a resource utilization of the customer within each of multiple fixed time increments across repeated instances of a seasonal cycle; identifying a temporal location of an anomaly detection period within the seasonal cycle; determining a distribution of seasonally-relevant values of the resource utilization metric based on the historical usage data, wherein each value in the distribution of seasonally-relevant values corresponds to the temporal location within one of the repeated instances of the seasonal cycle; defining a smoothed dataset by applying a smoothing function to smooth each of multiple fixed-length windows within the distribution of seasonally-relevant values; and defining an anomaly detection threshold for the customer based on a configurable percentile of the smoothed dataset; observing an actual resource utilization for the customer during the anomaly detection period; and automatically generating an anomaly alert in response to determining that the actual resource utilization of the customer exceeds the anomaly detection threshold computed for the customer.

In some aspects, the techniques described herein relate to one or more tangible processor-readable storage media, wherein the historical usage data is specific to the customer and the distribution of seasonally-relevant values consists of customer-specific historical values for the resource utilization metric that correspond to the temporal location within the repeated instances of the seasonal cycle.

In some aspects, the techniques described herein relate to one or more tangible processor-readable storage media, wherein computing the anomaly detection threshold further includes: determining a value corresponding to a configurable percentile of the smoothed dataset; determining a buffer term by multiplying the value by a customer-specific parameter, the customer-specific parameter having a value that is set, at least in part, based on feedback from the customer in response to previously-generated anomaly alerts; and adding the value to the buffer term.

In some aspects, the techniques described herein relate to one or more tangible processor-readable storage media, wherein the process further includes: receiving feedback from the customer indicating that the anomaly alert did not correspond to an actual anomaly; in response to the feedback, generating an updated value for the customer-specific parameter by increasing a previous value of the customer-specific parameter; re-generating the anomaly detection threshold for the customer for a different detection period based on the updated value. The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, depending on the computer system's performance requirements. Accordingly, the logical operations making up the implementations described herein are referred to variously as operations, steps, objects, or modules. Furthermore, it should be understood that logical operations may be performed in any order unless explicitly claimed otherwise or a specific order is inherently necessitated by the claim language. The above specification, examples, and data, together with the attached appendices, provide a complete description of the structure and use of exemplary implementations.

What is claimed is:

1. A method for detecting a resource utilization anomaly within a cloud computing platform, the method comprising:
determining, for a customer of the cloud computing platform, a historical utilization distribution that defines values of a resource utilization metric for each of multiple fixed time increments across repeated instances of a seasonal cycle;
identifying a temporal location of an anomaly detection period within the seasonal cycle;
filtering the historical utilization distribution to construct a distribution of seasonally-relevant values of the resource utilization metric, each value in the distribution of seasonally-relevant values corresponding to the temporal location within one of the repeated instances of the seasonal cycle;
computing, based on the distribution of seasonally-relevant values, a resource utilization prediction that quantifies a predicted resource utilization for the customer during the anomaly detection period;
observing an actual resource utilization for the customer during the anomaly detection period; and
automatically generating an anomaly alert in response to determining that the actual resource utilization of the customer satisfies a predefined relationship with the resource utilization prediction.

2. The method of claim 1, wherein the historical utilization distribution is specific to the customer and the distribution of seasonally-relevant values consists of customer-specific historical values for the resource utilization metric.

3. The method of claim 1, wherein the historical utilization distribution includes historical resource usage data collected for a group of customers identified as sharing a characteristic with the customer, the characteristic being selected from a group comprising:
an industry of goods or services offered by the customer;
a subscription tier of the customer;
a geographical location associated with the customer.

4. The method of claim 2, wherein computing the resource utilization prediction further comprises:
determining a value corresponding to a configurable percentile for the distribution of seasonally-relevant values; and
computing the resource utilization prediction based on the value.

5. The method of claim 2, wherein computing the resource utilization prediction further comprises:
defining a smoothed dataset by applying a smoothing function to smooth each of multiple fixed-length windows within the distribution of seasonally-relevant values; and
defining an anomaly detection threshold based on a configurable percentile of the smoothed dataset.

6. The method of claim 4, wherein computing the resource utilization prediction further comprises:
determining a buffer term by multiplying a customer-specific parameter by the value, the customer-specific parameter having a value that is set, at least in part, based on feedback from the customer in response to a previously-generated anomaly alert, wherein the resource utilization metric is based on a sum of the value and the buffer term.

7. The method of claim 6, further comprising:
receiving feedback from the customer indicating that the anomaly alert did not correspond to an actual anomaly;
in response to the feedback, generating an updated value for the customer-specific parameter by increasing a previous value of the customer-specific parameter;
re-generating the resource utilization prediction for a different detection period based on the updated value.

8. The method of claim 1, wherein the cloud computing platform includes a virtual network configured for the customer and automatically generating the anomaly alert further comprises:
temporarily blocking a flow of communications between the customer and the virtual network;
prompting the customer to provide a credential to a security provider and
restoring the flow of communications in response to successful authentication of the credential.

9. A system comprising:
a cloud computing platform that provides processing resources to a cloud customer; and
an anomaly detector stored in memory and deployed within the cloud computing platform to:
observe an actual resource utilization of a cloud customer during an anomaly detection period;
determine a historical utilization distribution for the cloud customer that defines values of a resource utilization metric for each of multiple fixed time increments across repeated instances of a seasonal cycle;
identify a temporal location of the anomaly detection period within the seasonal cycle;
construct a distribution of seasonally-relevant values of the resource utilization metric based on the historical utilization distribution, the distribution of seasonally-relevant values including values within the historical utilization distribution that correspond to the temporal location within the repeated instances of the seasonal cycle;
compute, based on the distribution of seasonally-relevant values, a resource utilization prediction that quantifies a predicted resource utilization for the cloud customer during the anomaly detection period; and
automatically generate an anomaly alert in response to determining that the actual resource utilization of the cloud customer exceeds the resource utilization prediction computed for the cloud customer.

10. The system of claim 9, wherein the historical utilization distribution is specific to the cloud customer and the distribution of seasonally-relevant values consists of customer-specific historical values for the resource utilization metric that correspond to the temporal location within the repeated instances of the seasonal cycle.

11. The system of claim 9, wherein the historical utilization distribution includes historical utilization data collected for a group of customers identified as sharing a characteristic with the cloud customer, the characteristic being selected from a group comprising:
an industry of goods or services offered by the cloud customer;
a subscription tier of the cloud customer; and
a geographical location associated with the cloud customer.

12. The system of claim 9, wherein the anomaly detector is configured to compute the resource utilization prediction by performing operations that include:
determining a value corresponding to a configurable percentile for the distribution of seasonally-relevant values; and
computing the resource utilization prediction based on the value.

13. The system of claim 9, wherein the anomaly detector determines is configured to compute the resource utilization prediction by performing operations that include:
defining a smoothed dataset by applying a smoothing function to smooth each of multiple fixed-length windows within the distribution of seasonally-relevant values; and
defining an anomaly detection threshold based on a configurable percentile of the smoothed dataset.

14. The system of claim 12, wherein computing the resource utilization prediction further comprises:
determining a buffer term by multiplying a customer-specific parameter by the value, the customer-specific parameter having a value that is set, at least in part, based on feedback provided by customer in response to a previously-generated anomaly alert; and
adding the value to the buffer term
wherein the resource utilization prediction is based on a sum of the value and the buffer term.

15. The system of claim 14, wherein the anomaly detector is further configured to:
receive feedback from the cloud customer indicating that the anomaly alert did not correspond to an actual anomaly; and
in response to the feedback, generating an updated value for the customer-specific parameter by increasing a previous value of the customer-specific parameter;
re-generating the resource utilization prediction for a different detection period based on the updated value of the customer-specific parameter.

16. The system of claim 12, wherein the cloud computing platform includes a virtual network configured for the cloud customer and automatically generating the anomaly alert further comprises:
temporarily blocking a flow of communications between the cloud customer and the virtual network;
prompting the cloud customer to provide a credential; and
restoring the flow of communications between the cloud customer and the virtual network in response to successful authentication of the credential.

17. One or more tangible processor-readable storage media encoding instructions for executing a process comprising:
accessing a database to retrieve historical usage data for a customer of a cloud computing platform, the historical usage data including values of a resource utilization metric quantifying a resource utilization of the customer within each of multiple fixed time increments across repeated instances of a seasonal cycle;
identifying a temporal location of an anomaly detection period within the seasonal cycle;
determining a distribution of seasonally-relevant values of the resource utilization metric based on the historical usage data, wherein each value in the distribution of seasonally-relevant values corresponds to the temporal location within one of the repeated instances of the seasonal cycle;
defining a smoothed dataset by applying a smoothing function to smooth each of multiple fixed-length windows within the distribution of seasonally-relevant values; and
defining an anomaly detection threshold for the customer based on a configurable percentile of the smoothed dataset;
observing an actual resource utilization for the customer during the anomaly detection period; and
automatically generating an anomaly alert in response to determining that the actual resource utilization of the customer exceeds the anomaly detection threshold computed for the customer.

18. The one or more tangible processor-readable storage media of claim 17, wherein the historical usage data is specific to the customer and the distribution of seasonally-relevant values consists of customer-specific historical values for the resource utilization metric that correspond to the temporal location within the repeated instances of the seasonal cycle.

19. The one or more tangible processor-readable storage media of claim 17, wherein computing the anomaly detection threshold further comprises:
determining a value corresponding to a configurable percentile of the smoothed dataset;
determining a buffer term by multiplying the value by a customer-specific parameter, the customer-specific parameter having a value that is set, at least in part, based on feedback from the customer in response to previously-generated anomaly alerts; and
adding the value to the buffer term.

20. The one or more tangible processor-readable storage media of claim 19, wherein the process further comprises:
receiving feedback from the customer indicating that the anomaly alert did not correspond to an actual anomaly;
in response to the feedback, generating an updated value for the customer-specific parameter by increasing a previous value of the customer-specific parameter;
re-generating the anomaly detection threshold for the customer for a different detection period based on the updated value.
